(19) United States
(12) Patent Application Publication
(10) Pub. No.: US 2025/0182285 A1
(43) Pub. Date: Jun. 5, 2025

(54) METHOD FOR GENERATING A DIFFERENTIAL MARKER ON A REPRESENTATION OF A PORTION OF THE HUMAN BODY

(71) Applicant: SQUAREMIND, PARIS (FR)

(72) Inventors: Ali KHACHLOUF, PARIS (FR); Tanguy SERRAT, SAINT-CLOUD (FR)

(21) Appl. No.: 18/873,604

(22) PCT Filed: Jun. 15, 2023
(86) PCT No.: PCT/EP2023/066170

§ 371 Date: Dec. 10, 2024

(30) Foreign Application Priority Data
Jun. 15, 2022 (FR) FR2205843

(51) Int. Cl. G06T 7/00

(52) U.S. Cl. CPC G06T 7/0016; G06T 2207/20084; G06T 2207/30088

(57) ABSTRACT

A method for generating at least one differential marker of the presence of a skin singularity of a human body, the method including acquisition of a first and a second set of dermoscopic images of singularities of the skin of a human body of a first individual at a first and respectively a second date; generation of a first and a second representation of a first image of a part of the human body and of a first symbol respectively a second symbol superimposed on the first image of each representation at a position in a first reference frame of the first image, the geometry and/or the color of the second symbol being different from the geometry and/or the color of the first symbol when the second class of the dermoscopic image of the second set is different from the first class of the dermoscopic image of the first set.

### INVENTION FIELD

The field of the invention relates to computer-implemented methods for generating markers on a representation of the human body. The field of the invention relates more particularly to systems and processes for assisting a doctor such as a dermatologist in the analysis of skin singularities on the body surface.

### STATE OF THE ART

Today, dermatologists analyze skin singularities by examining a patient's skin surface with the naked eye.

Current imaging devices offer practitioners a limited choice. Most often, a dermatologist can access dermoscopic images at 10× to 30× magnification of a few lesions, taken individually using a hand-held dermatoscope such as a “gun”. Alternatively, he can access macroscopic images of a body, using whole-body imaging systems, such as a “booth”, enabling whole-body acquisition.

These two techniques can be used in combination, but at best they only provide a macroscopic image of the whole body, with a few dermoscopic lesions obtained by manually associating dermoscopic images with a particular area of the body.

As a result, there are no full-body imaging or skin maps that provide access to dermoscopy images at any point.

A number of existing systems can take photos of the skin at different resolutions. These systems enable macroscopic observation of moles, for example. However, it is important to take images at different times, ideally in dermoscopy, to monitor the evolution of a singularity over time. The doctor must therefore save the images, associate them with an area of the body so as to be able to compare them with the correct images at a later date, and finally orientate and display them in the same way to compare the images with each other during an examination.

To date, however, there is no process or system that addresses all these issues.

### SUMMARY OF THE INVENTION

According to a first aspect, the invention relates to a computer-implemented method for generating at least one differential marker of the presence of a skin singularity of a human body, said method comprising:
Reception at a first date of at least a first image of all or part of the human body, called first body part, of a first individual for displaying a dermoscopic image extracted from said first image with a dermoscopic resolution, said first image comprising a plurality of cutaneous singularities of the skin of said body, each singularity having coordinates in a first reference frame associated with said first image and being associated with a first date and with at least a first value of a first descriptor;
Reception at a second date of at least one second image of the same first part of the human body of the first individual with a substantially identical resolution, said second image comprising a plurality of cutaneous singularities of the skin of said body, each singularity having coordinates in a first reference frame associated with said second image and being associated with a second date and with at least one second value of the first descriptor;
Generation of a first representation comprising the first image and at least one first symbol associated with a first singularity located at a first position of said first image of the first reference frame, said at least one first symbol being superimposed on the first image at the first position, said first symbol having a first geometry and/or a first color generated as a function of at least the first value of the first descriptor considered at the first date;
Generation of a second representation in the vicinity of the first representation comprising the second image and at least one second symbol associated with the first singularity, said second symbol having a second geometry and/or a second color, said at least one second symbol being superimposed on the second image at the first position, said second geometry and/or said second color being different from the first geometry and/or the first color thus defining a differential marker, when the calculated distance between a first value of the first descriptor calculated at the first date and a second value of the first descriptor calculated at the second date is greater than a predefined threshold.

One advantage is that it provides a simple tool for comparing two images of the skin acquired at different times, while at the same time offering easily accessible tools for viewing areas of interest and assessing how a situation is evolving.

In one embodiment, the method comprises generating a graph comprising a set of nodes, said nodes corresponding to singularities, each node comprising attributes, including a position of the singularity and at least one value of a descriptor.

One advantage is that the two images can be merged at the same reference point, so that the two parts of the human body can be displayed in the same way at two different times.

In one embodiment, the two images of each representation are oriented and aligned with each other by means of a step that compares and/or merges the two graphs and minimizes the error in the positional deviation of the nodes between them.

One advantage is that it makes it easier to read and analyze a singularity by providing a better viewing context for detecting discrepancies from one image to another.

According to one embodiment, at least one feature vector is calculated at each node of the first graph and of the second graph by a machine learning model, said model receiving as input an image of a singularity and generating as output a feature vector of the similarity of said image.

According to an embodiment, the comparison step implements the optimization of a cost function of the calculation of a distance between two graphs taking into account:
a first distance between the nodes of the first graph and the nodes of the second graph, said first distance using a geometric metric for calculating a distance between points in space,
a second distance between the nodes of the first graph and the nodes of the second graph, said second distance using a metric for calculating a distance between feature vectors.

In one embodiment, by optimizing the cost function of the distance between the two graphs, a transformation is applied to each node of the first graph to make it correspond to a node of the second graph.

In one embodiment, optimizing the cost function of the distance between the two graphs enables a non-rigid transformation to be applied.

In one embodiment, each graph comprises between 5 and 600 nodes. More specifically, the range of nodes for certain individuals with characteristic skin is between 50 and 500 nodes.

According to another aspect, the invention concerns a computer-implemented method for linking two images each having dermoscopic resolution of all or part of a human body and being received at two different dates, said method comprising:
Reception at a first date of at least a first image of all or part of the human body, called first body part, of a first individual for displaying of a dermoscopic image extracted from said first image with a dermoscopic resolution, said first image comprising a plurality of cutaneous singularities of the skin of said body, each singularity having coordinates in a first reference frame associated with said first image and being associated with a first date and at least a first value of a first descriptor, each singularity located in the first image defining a node of a first graph;
Receipt at a second date of at least one second image of the same first part of the human body of the first individual with substantially identical resolution, second image comprising a plurality of cutaneous singularities of the skin of said body, each singularity each having coordinates in a first reference frame associated with said second image and being associated with a second date and with at least one second value of the first descriptor, each singularity located in the second image defining a node of a second graph;
Generation of a first representation including the first image;
Computation of a matching vector from the comparison of a plurality of singularity positions and at least one value of at least one descriptor of said singularities of the first graph and the second graph;
Generation of a second representation in the vicinity of the first representation comprising the second image, said second representation being generated so that the first and second images are oriented according to the same reference frame or are displayed according to the same dimensional scale.

This aspect of the invention can be combined with all the embodiments of the other aspects.

According to one embodiment, each singularity of the first image is associated with a plurality of descriptors comprising at least one descriptor from the following list:
A contrast value with respect to a value representative of an average color considered in the vicinity of the skin singularity;
A given class of a classifier of a neural network output having been trained with dermoscopic images of skin singularities;
A characterization of a geometric shape datum.
A score corresponding to a scalar value or a numerical value obtained by implementing an algorithm processing as input an image extracted from the first image,
A score obtained by calculating different values of singularity descriptors considered in the vicinity of a given singularity.

One advantage is that a category or value of a singularity can be identified, facilitating the association of a symbol type according to the category of the singularity under consideration.

According to an embodiment, when a class is associated with a singularity after acquired images of the skin are supplied to a neural network configured to output a classification of said supplied images, at least one class is included among the following list of classes:
a class relating to the geometry of the periphery of the singularity of a given dermoscopic photo,
a class relating to the characterization of a geometry of the periphery of the singularity of a given dermoscopic photo with respect to a plurality of characterizations of geometries of peripheries of singularities of other dermoscopic photos considered in the vicinity of the given dermoscopic photo;
a class related to the color of a singularity;
a class relating to the asymmetry of the geometry of the periphery of the singularity of a given dermoscopic image,
a class relating to the diameter of the geometry of the periphery of the singularity of a given dermoscopic image, when said singularity has a substantially circular shape,
a class relating to the area in which the singularity is present on the human body.

One advantage is that it inherits classes from a neural network classifier at the level of singularity and therefore also position in the first image.

In one embodiment, an evolution criterion is calculated, quantifying the evolution of a singularity descriptor between two images from two acquisitions made at two different dates.

One advantage is that it can draw attention to changes or evolutions in singularity over time.

According to one embodiment, an evolution criterion is calculated from a distance defined between a first value of a descriptor of a first node of a first graph acquired at a first date and a second value of a descriptor of a second node of a second graph acquired at a second date, each graph being generated from a first image, respectively a second image, said images corresponding to a body of a same individual and the first node and the second node having the same position within the first and second image.

One advantage is that it quickly enables differential calculations between two singularities in two images taken on two different dates, whose positions are known in two different frames of reference and in each other's frame of reference. The use of graphs makes it very easy to corroborate the positions of singularities, notably on the basis of position correspondences and descriptor similarities. This makes it much simpler to match the two benchmarks of the two images received, to facilitate comparisons of the descriptor values of a singularity that has evolved over time.

According to one embodiment, each singularity has a calculated position in the first image or the second image that corresponds to a geometric point characteristic of a shape characteristic of the geometry of said singularity. This may be an oval, an ellipse, a circle, a rectangle or a triangle.

According to one embodiment, the color and/or geometry of a symbol is/are selected according to:
a criterion for a singularity to belong to at least one class of the classifier;
a descriptor value exceeding a threshold value;
the value of an evolution criterion of a singularity descriptor calculated between two first images acquired at two dates.

One advantage is that it allows a wide configuration of representation of the different demarcation criteria of a given singularity, or of a singularity's evolution over time.

In one embodiment, the shape of the symbol is a simple geometric shape such as a circle, triangle, square, rectangle, cross or star.

In one embodiment, the color of the symbol is generated according to a color gradient associated with the evolution over time of a value of a descriptor of a singularity according to a predefined scale of values.

According to an embodiment, a third symbol is generated according to a given color and/or shape when a singularity is present in a first image acquired at a given position for the first time, said color or shape of the third symbol enabling said symbol to be distinguished from another symbol to indicate the new appearance of said singularity.

One advantage is to represent the appearance of a singularity that has not been identified in previous image acquisitions.

In one embodiment, user interaction with at least one displayed symbol generates a first digital command to display at least one dermoscopic image in a display window, said displayed dermoscopic image corresponding to an image extracted from the first image associated with the position at which the symbol is displayed on the first image.

One advantage is that it can directly exploit the overall image of a patient's body without having to “stitch” or process images taken by another device onto a macroscopic image.

In one embodiment, a second digital instruction generated by a user action displays two side-by-side dermoscopic images extracted respectively from a first image and a second image, said two dermoscopic images displaying the singularities of the same position on the body at the same resolution and on the same dimensional scale.

One advantage is that we can take advantage of the graphs associated with the first and second images. The graphs are easy to manipulate and enable simple registration between the first and second images, as only the descriptors and node positions are considered.

In one embodiment, a second digital instruction generated by a user action enables two dermoscopic images to be displayed side by side, said two dermoscopic images enabling singularities having the same position on the body to be displayed in the same orientation.

In one embodiment, the first image and the second image are 2D images of a part of the human body. One advantage is that body parts are displayed in a flat view. This view enables better manipulation of the displayed image, particularly rotation and zooming.

In one embodiment, the first image and the second image are 3D images of a part of the human body. One advantage is to better represent a patient's body and quickly visualize an area of interest.

In one embodiment, a numerical command to move, zoom or select an area of interest in the first image of the first representation automatically generates an identical numerical command for an equivalent area of interest in the second image of the second representation. One advantage is that the representations of the two images can be coordinated during an examination of the human body represented on a computer, taking into account a temporal evolution criterion.

According to one embodiment, a first numerical control is used to orient a three-dimensional digital avatar of the human body so as to display a body portion selectable by a second numerical control producing the display of a first image, said first image representing a plurality of singularities of the skin of said displayed portion, a set of symbols being represented with a geometry and a color dependent on at least one value of a descriptor of the singularity.

According to one embodiment, a first numerical control is used to orientate a three-dimensional digital avatar of an individual's body so as to display a portion of the body, a third numerical control being used to magnify the said portion of the body displayed on an area of interest, said area of interest displaying a plurality of markers each having a position on the surface of the human body in a reference frame associated with the digital avatar, each marker being associated with a singularity of the human body, a fifth digital command for selecting said marker to display a dermoscopic image extracted from the first image, said extracted image being defined around the position of the selected marker.

In one embodiment, dermoscopic images are acquired by an image-taking device configured to acquire a plurality of images of the skin of an individual's human body and to assign each image a position on a 3D model representing said individual's body.

According to one embodiment, the 3D model representing the individual's body corresponds to the three-dimensional representation enabling navigation over different portions of the body.

According to one embodiment, the method comprises a step for detecting a set of singularities on the body surface, comprising the execution of a neural network processing as input images of the skin acquired by an image acquisition device and generating as output a classification of said image, each of the images being indexed according to a position on the surface of a 3D body model reconstructed from a depth map generation.

According to another aspect, the invention concerns a system comprising an electronic terminal including a display for generating images produced by the method of the invention and a data exchange interface for receiving images acquired by an image acquisition device or another computer or memory when said received images have been previously processed subsequent to their acquisition by an image-taking device.

Another object of the invention concerns a method for acting on an image of the whole or part of the human body having a dermoscopic resolution so as to visualize on the one hand images of cutaneous singularities of the skin on a dermoscopic scale and on the other hand an image of the whole or part of the body on a macroscopic scale.

One advantage of the invention is that skin maps can be generated to provide access to given areas of the skin using magnification functions down to dermoscopic level.

One advantage is that it enables access to any image acquired and associated with a point on a representation of the body, in particular points corresponding to areas of virgin skin, or points corresponding to pigmented or non-pigmented lesions.

### BRIEF DESCRIPTION OF FIGURES

Further features and advantages of the invention will become apparent from the following detailed description, with reference to the appended figures, which illustrate:

FIG. 1: a three-dimensional representation of a human body allowing navigation to select a body portion;

FIG. 2: two representations of the same image showing the torso of a human body at two different dates, each image comprising a set of singularities of the human body and a plurality of symbols enabling certain singularities to be distinguished from others;

FIG. 3: a representation of an image of a portion of the human body providing access to a dermoscopic photograph of a singularity;

FIG. 4: a representation of an image of a portion of the human body providing access to two dermoscopic photographs of a singularity obtained on two different dates.

FIG. 5: an example of a system of the invention.

The term “dermoscopic image” refers to an image acquired by an optical system, enabling the formation of a close-up image of a portion of the skin. In the following description, a dermoscopic image corresponds in the broadest sense to an image of an area of skin magnified to the size of the area imaged. Magnification therefore includes an operation aimed at representing an area with a larger scale than the scale corresponding to its actual size.

In particular, the invention refers to dermoscopic images with magnifications of the order of 10× to 30× of the actual size of the skin area under consideration, i.e. between ten times and thirty times the size of the actual area. According to one example, the dermoscopic image can be associated with a given resolution or above a given threshold.

Finally, according to another example, the dermoscopic image can refer to an image acquired by a device or instrument designed to image areas of the skin. This may be a dermatoscope, which exists in different variants:
Contact or contactless equipment;
Equipment projecting polarized or unpolarized light;
Equipment with optics for acquiring digital images,
Conventional equipment such as a magnifying glass without acquisition.

According to another example, the process of the invention can be carried out using images acquired from certain devices up to a magnification of 400×, i.e. 400 times.

Any image with dermoscopic resolution is an image, regardless of its size, that can be zoomed or magnified so as to display images at dermoscopic scale, i.e. an image with a magnification between 10× or 30× of the actual size of the singularity represented on an individual's body.

Body model” refers to a body model produced by a 3D scan of an individual's body, including images of the skin in each pixel of a three-dimensional representation. The term “body” refers to all or almost all of the body, although certain parts of the body may be deliberately masked without declassifying the term “body”.

A skin singularity is defined as an area contrasting with the average color of the skin in its vicinity, or as an asperity of the human body localized at a point on the body. Color or intensity thresholds can be defined to determine whether the area comprises a singularity. In other cases, a singularity may be characterized by a zone comprising a gradient of colors or intensities. These may be in the visible light range or in other parts of the spectrum such as the UV or infrared spectrum. i.e. multispectral/hyperspectral.

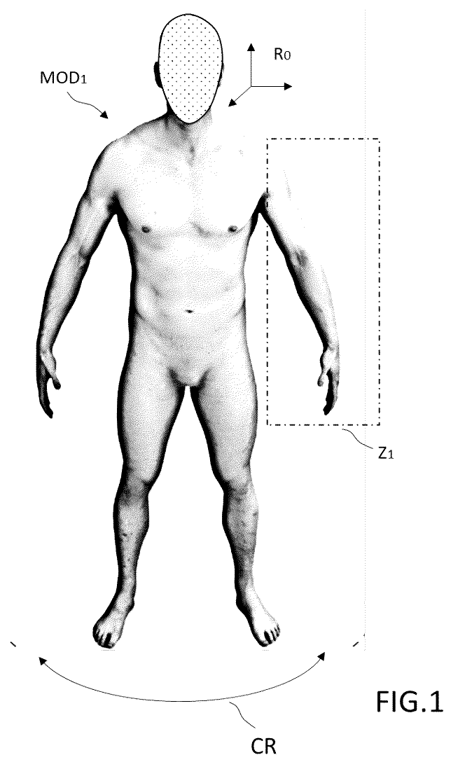

FIG. 1 shows a 3D representation of an individual's body. This image may correspond to the first image IM₁, which has dermoscopic resolution and can be zoomed in directly to obtain an image of an SG singularityᵢ on a dermoscopic scale. Alternatively, this representation can be used, for example by a computer, to select an area of the body such as the Z₁ area representing the arm of the body.

According to one example, a CR command enables a computer user to orientate the 3D image of the body according to the view he wishes to display and exploit. In this way, for example, the back or torso of a body can be viewed. To this end, a command is used to rotate the body along an axis of revolution defined here by the axis parallel to the axis along which the body extends along its longest dimension. According to one example, other commands enable the body to be oriented around another axis, which may be a roll, pitch or yaw axis. According to one example, a translation can also be defined. If the 3D image is the first image received with dermoscopic resolution, this can be manipulated to zoom in on a dermoscopically scaled image.

User commands are used to generate CONS₂ digital instructions for moving, modifying, zooming, orienting or coordinating the display of the two images. Different digital commands CDN₁ for moving an area of interest, CDN₂ for orienting the avatar along at least one axis, CDN₃ for enlarging an area of interest, CDN₄ for selecting a marker positioned in the first image or the second image relative to a singularity for displaying an image extracted from the first image at a dermoscopic scale can result in generating different operations on the displayed image or on the two images displayed in each representation.

When a user selects a marker of interest or an image symbol, a digital instruction CON1 is generated, which can be interpreted by a computer and generates a window in which a dermoscopic resolution image extracted from the first image or the second image is displayed at dermoscopic scale.

In one example, a CDN₀ command can be used to zoom in on an area of the human body displayed on the screen. Thus, once a view has been selected, for example that of the front of an individual U₁, it is possible to zoom in on just one part of the body, such as the torso or the arm. Alternatively, it is possible to select an area of the body in order to generate a representation in another window.

The representation can be a 2D or 3D view. In the example shown in FIG. 1, it is a three-dimensional representation, but a 2D representation could alternatively be chosen. This 2D representation may concern the whole body or a part of it. In order to obtain a 2D representation of a 3D surface, a portion of the 3D surface is cut along delimiting lines to generate a flat area for representation on screen.

The invention therefore includes a first representation enabling navigation within the surface of the human body by operations such as orientation modification, area selection or magnification.

According to a first example, the representation of the human body, such as that shown in FIG. 1, is an avatar independent of the faithful representation of an individual's body, and is denoted MOD₁.

According to a second example, the representation of the human body as shown in FIG. 1, is a faithful avatar of the body of an individual MOD₀ which has been scanned from an image acquisition device. The avatar can be represented and oriented in a reference frame R₀ linked to the individual's body. When this representation is carried out, it is based on the use of a 3D model of a human body, each surface point of which is indexed in an R₀ coordinate system linked to the body model. The invention is compatible with whole-body imaging devices that can produce macroscopic images of the human body from which a faithful body model can be produced.

In both cases, a plurality of dermoscopic images are stored in a memory to produce a single IM₁ image of all or part of the human body.

The process of the invention can begin with the step of receiving the first IM image₁. However, a step to detect skin singularities on the surface of the scanned body can be carried out beforehand. The aim of this operation is to associate a position of a MOD₀ body model with each singularity. In this way, when the 3D representation directly exploits the 3D model, the positions of the singularities indexed on the MOD₀ body model correspond to the positions of the markers generated on the surface of the represented human body and enabling access to the dermoscopic images.

The position of singularities can also be indexed on a 2D image in a reference frame noted R₁.

When a 3D avatar is generated to represent a standard model of a human body, markers generated on the surface of this representation are generated at positions corresponding to positions indexed on the MOD₀ body model which is faithful to the scan obtained of an individual's body. A coordinate transformation matrix can be used to generate coordinates from a faithful body model to a standard body model.

In one embodiment, descriptors are associated with each singularity.

In one embodiment, the coordinates of points in a faithful 3D model of an individual's human body are transposed into a 2D representation from a standard representation of a human body using a coordinate transformation matrix.

According to one embodiment, the system of the invention comprises an actuator such as a computer mouse and a pointer or touch control for performing operations on the avatar such as a CR rotation noted in FIG. 1.

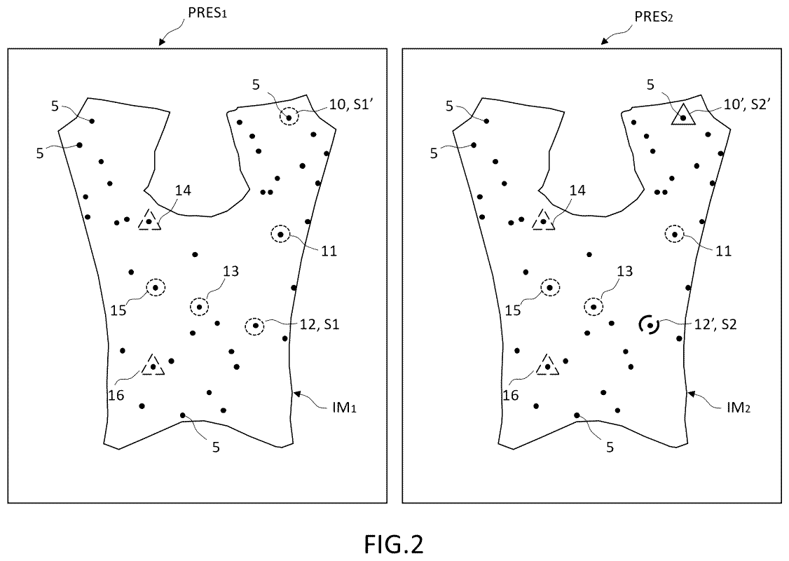

FIG. 2 shows two representations of two images IM₁, IM₂ of the same part of a human body of the same individual U₁ acquired on two different dates. Images IM₁ and IM₂ are preferably displayed with the same scale and orientation. They correspond to two 2D representations of a body portion, such as an individual's torso.

According to one embodiment, the 2D representation of the human body portion is directly extracted from a body model MOD₀ faithful to an individual's body resulting from a scan operation of said individual. In the latter case, if the images are extracted from a body model that has evolved over time, for example because a long period of time separates the two acquisitions and the individual has been on a diet, then the two images IM₁ and IM₁′ are different. In other words, the body model M₀ is different, or the first image is different, as skin pixels may have changed, or singularities may also have changed.

However, for the remainder of the description, the IM₁ and IM₂ images of each representation will be taken to refer to equivalent parts of the human body.

Each representation of a portion of the human body comprises an image IM₁ and a plurality of symbols S₁, S₂ indicating that a plurality of singularities SG₁ associated with the plurality of symbols belongs to a class of a given classifier. By way of example, this could be a mole, a pimple, an angioma, a scar, etc., or a particular type of each of its elements. Typically, there may be different classes of skin lesions and different classes of scars.

The invention's method makes it possible to retrieve information from an existing classifier in order to assign the class to the singularity detected and positioned in the IM₁ or IM₂ image. To this end, a neural network can be configured according to a given training in order to produce an output classifier for classifying the images given as input to the network. This step, as mentioned above, is preferably a preliminary step in the process of the invention.

Symbols can be geometric shapes such as circles, ovals, squares, triangles, hexagons, stars and so on.

Each symbol can also include a color, the color can also be chosen automatically to be associated with a class of a classifier. One interest is to enable an intuitive display for a user of a representation of a portion of a human body indicating areas of interest while qualifying the area of interest. The area of interest in this case may refer to a singularity positioned at a position in the first IM image₁ and/or the second IM image.

In one embodiment, each singularity is represented by a marker 5 that is independent of the classification of the associated dermoscopic image.

FIG. 2 shows a plurality of markers 5 within each image and a plurality of symbols S₁, S₁′, S₂, S₂′ on each representation.

In the case of FIG. 2, the two representations correspond to two different dates of acquisition DATE₁, DATE₂ of the first and second images IM₁, IM₂ with dermoscopic resolution of the human body. They may correspond to two patient visits spaced 6 months apart, for example.

In the PRES₁ representation, two symbols 14 and 16 can be identified by a triangle, which may indicate that the singularities are of the same type. These symbols do not appear to have changed class in the second PRES₂ representation, since their geometry and color have not changed. Color is interpreted here by the shape of the dashes forming the outline of the geometric shape.

Note that the four symbols 10 12, 13 and 15 can be identified by a circle and may indicate that the singularities are of the same type and therefore of a different type than the singularities associated with symbols 14 and 16. Some of these symbols have changed in the second PRES₂ representation. Symbol 12 has become symbol 12′ and appears to have changed color. Remember that the lines forming the outline of the shape here represent color. The shape of symbol 10 has changed geometry. Symbols 15, 13 and 11 have neither changed geometric shape nor color.

At a glance, a doctor can, for example, draw attention to peculiarities that need to be examined in greater depth.

In this case, some singularities may have a malignancy due to an evolution of the singularity's shape contour or to the fact that they have been changed classes in the classifier or vice versa.

The invention saves time when examining a patient, and reduces human error, for example in subjects with many peculiarities.

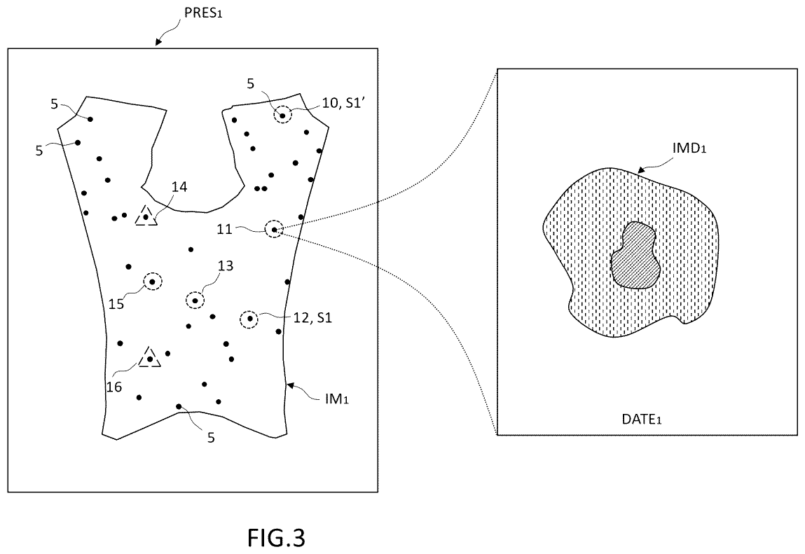

FIG. 3 shows a PRES₁ representation of an image superimposed with markers 5 and symbols S₁, S₁′. FIG. 3 also shows an IMD₁ dermoscopic image taken on a DATE₁ date. This dermoscopic image can be displayed in a window following a user action on the first IM₁ image of the first PRES₁ representation. For example, a click from a mouse pointer activates the display of a window in which an IMD₁ dermoscopic image is shown. This image represents a singularity associated with symbol 11 of the IM image₁. The IMD₁ dermoscopic image displayed is, for example, extracted from the IM₁ image according to a predefined size of a predefined framing around the position of the singularity. According to one example, the framing takes into account the geometry of the singularity's contour so as to display the entire singularity. In this way, the magnification size of the singularity can be adapted to a defined framing dimension.

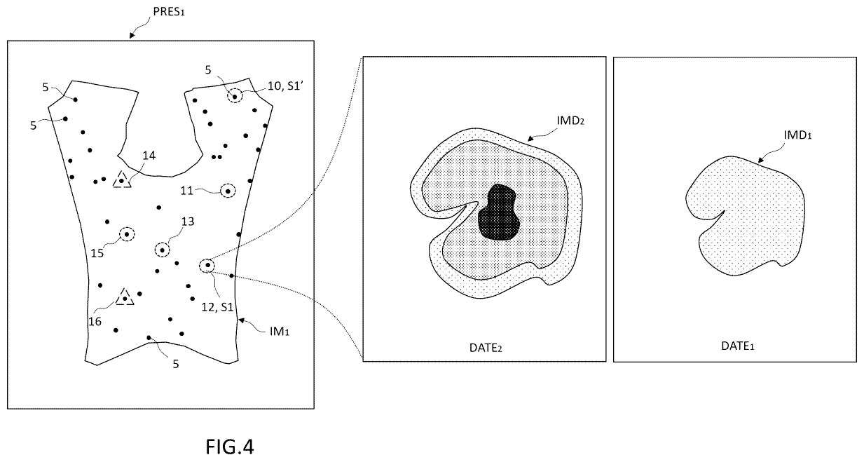

FIG. 4 illustrates the PRES₁ representation in which the IM₁ image is displayed following an operator action at symbol 12 superimposed on the IM₁ image. A first dermoscopic image IMD₁ is displayed in a first window and automatically a second dermoscopic image IMD₂ extracted from a second image IM₂ acquired at a date prior to DATE₁, for example at DATE₀ is displayed in a second window in the vicinity of the first window. The second window can be displayed automatically when the shape or color of the symbol is associated with a change in the singularity of the same position. It can also be a new symbol associated with a previously unclassified singularity newly classified in a given class of the classifier during the last acquisition, i.e. at the most recent date.

Thus, the geometric or colorimetric characteristic of a symbol associated with a dermoscopic image of a given singularity can be affected by a class assigned to said dermoscopic image, or by a change of class assigned to said dermoscopic image, or by the assignment of a first class of the classifier to said dermoscopic image, or by the result of a mathematical operation performed on characteristics calculated from two singularities of the same position considered at two different dates.

An advantage of the invention is to produce a system output by means of an interface offering to display skin maps by part or whole body from macroscopic to dermoscopic level with a magnification ranging from ×10 to ×30. To switch from one view to another, a zoom function can be activated.

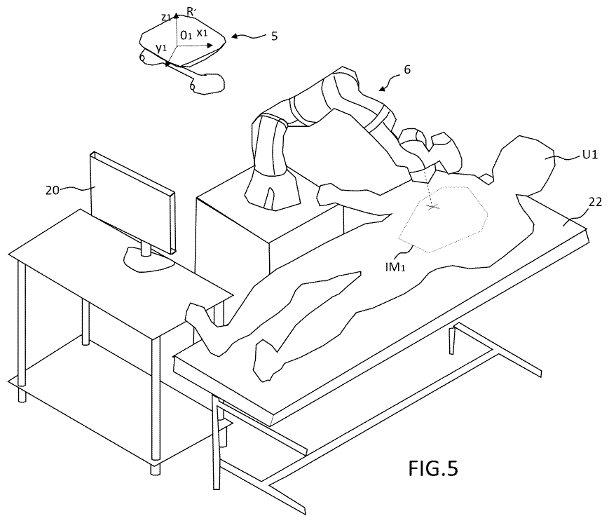

FIG. 5 shows an example of a system of the invention comprising a display 20 for displaying a first image and a second image produced by the process of the invention. The first image, like the second image, can be reconstructed from images acquired by an image acquisition device 6. In the case of FIG. 5, this is a mobile robot arm 6 that can be controlled by a trajectory computer. In this case, the user U₁ is lying on a table 22. In another embodiment, the acquisition device 6 can be a cabin with fixed or mobile optics, in which an individual U₁ is positioned, for example, in a standing position.

FIG. 5 also shows another acquisition device (5) located in a room for imaging a patient's body surface. This device is associated with a reference frame R′. This device can be used, for example, to image a macroscopic representation of the human body, and the optical device arranged in the distal part of the robot arm is configured, for example, to image areas of the body with dermoscopic resolution.

The first image and the second image can be reconstructed by aggregating images acquired by a dermoscopic resolution image acquisition device. In another embodiment, a composite image is produced by selecting the sharpest pixels from each acquired image of the human body. In one embodiment, images directly acquired by the image-taking device can be transmitted to a local or remote computer to feed a neural network trained with skin images. One advantage is that classes of the acquired images can be determined and reassigned to singularities positioned in an image reconstructed from the set of images.

In one embodiment, a singularity is identified when an image is classified in a given group of classes. For example, the group of classes forming singularities may include the mole class, the scar class and the carcinoma class. Other examples of classes may define the singularity class.

Each singularity image with dermoscopic resolution is indexed on a 3D model of an individual's human body. In one embodiment, the position of the singularity is associated with this indexing. By way of example, a point on the surface formed by the shape of the singularity can be used to define the position of the singularity on the 3D model. Another example is the barycenter of the shape delimiting the singularity. Another example is the center of the mean circle approaching the surface of the singularity.

Each singularity can have a position in the 2D image acquired by the optics and a position in the 3D image of the human body. An image of a singularity can be according to the embodiments:
a 2D image in the visible spectrum;
a multispectral or hyperspectral image;
a 3D image;
an ultrasound or confocal microscopy image
a biopsy image of the singularity;
a combination of all the above options

Each singularity defines the nodes of a graph and for this purpose comprises an identifier in the graph. In one embodiment, the graph of singularities comprises a plurality of nodes, each node being connected to its neighboring nodes according to a topological distance defined on the surface of the 3D model. Neighboring nodes can be considered geometrically close according to a defined metric, such as a Euclidean distance.

When the singularity graph is defined with nodes as singularity positions and edges as links between neighboring nodes, it is possible to construct feature vectors for each node and/or edge of the graph. These feature vectors can be defined as “embeddings” in GNN terminology. Embeddings enable information to be encoded for each node and/or edge, by encoding a datum characteristic of the node's and/or edge's neighborhood.

We describe an embodiment in which an embedding, referred to as a “feature vector” in the following, is calculated for each node.

One advantage of constructing a feature vector is to encode each node with its own data, such as a value that can form a node identifier or attribute. The feature vector of a node can be calculated by a machine learning method in which the input is the image of a singularity and the output is a feature vector. The machine learning model is trained, for example, with a given pair of images and the implementation of two neural networks that train their coefficients according to the response of a cost function that we seek to minimize. This method is used to train a machine learning model, which is then used to generate a feature vector from an image. One advantage is that the feature vector of a node can be used as a point of comparison to quantify the similarity between two nodes.

In one embodiment, the trained model is used to define a similarity function for calculating a distance between feature vectors between two graph nodes. The model is then trained so that the distance between two similar images is minimal when the images of the singularities are identical, and is maximal when the images are very different.

The machine learning model is preferably trained with a large number of images of different singularities, so as to build discriminating feature vectors that enable a high-performance distance function to be restored.

Inference of the trained model generates a given feature vector for an image of a singularity at a given node. This feature vector can then define an attribute or identifier of the considered node of the singularity graph.

In one embodiment, the characteristic vector of a node is calculated by taking into account neighboring nodes. In this way, at each node, the characteristic vector encodes a piece of information, or even a distance according to a given metric, considered between two neighboring nodes. It is then possible to calculate the values of the characteristic vectors of a node from a plurality of neighboring nodes, in order to iteratively calculate a characteristic vector that locally restores the level of similarity with the neighboring nodes. This method can be applied to each node of the singularity graph to generate a set of graph feature vectors. One advantage is that all the information about a graph, such as its structure and relationships, can be encoded by considering feature vectors that locally encode the topology of the graph at a node.

One advantage of feature vectors, also known as “embeddings”, is that they can be used to construct a numerical representation of a graph, which can then be used to train machine learning algorithms. In the case of the present invention, feature vectors have the advantage of making it possible to compare two graphs of singularities of the same individual from which two body models have been generated at two different dates. One of the aims of the invention is to represent the two body models in the same frame of reference and, more specifically, the dermoscopic quality images at each point of the body model. However, the body models taken at different dates of the same individual may have been acquired under different conditions, they may be disorientated from each other according to the 6 coordinates (3 rotations, 3 translations) or they may be different because the individual has changed, for example he or she may have put on weight or lost weight or had an operation in the interval between the two dates, thus modifying a portion of the graph.

In addition, one advantage of using singularities as nodes in a graph to match two graphs from two body models of the same individual is that it frees us from the position of “classic” nodes that would be calculated following the generation of a 3D body model. Indeed, in the case of a point cloud generated from a body scan operation defining a graph, the position of the nodes would be considered arbitrary when reconstructing the body model. Singularities make it possible to get away from the arbitrary position of the nodes considered on the surface of the body, in particular because they constitute a certain form of invariance for the individual, except for the new singularities.

In this way, a set of feature vectors is calculated for each node of the singularity graph.

In a first example, the algorithm for calculating a feature vector only takes into account data from a singularity, such as its image.

According to another example, the feature vector calculation algorithm is initiated by calculating an initial feature vector for a selected node, then the data or value defining the feature vector of the initial node is propagated to neighboring nodes. Each neighboring node in turn calculates its own characteristic vector and propagates this value in turn. This step can be carried out over several iterations to generate a set of feature vectors for all the nodes in the singularity graph. This technique relies on the passage of information between the nodes of the graph in order to calculate the set of characteristic vectors of the singularity graph. It is understood that when calculating a feature vector for a node, the so-called destination node, the latter takes into account data calculated by its neighbors in order to calculate its own feature vector. The operations performed to calculate a node's characteristic vector from its own data and data from neighboring nodes can include operations such as “average”, “sum”, “maximum”, etc. The calculation of a characteristic vector for a node is, for example, calculated following several iterations, i.e. several information passages between neighboring nodes of a given node so as to encode local information of the given node. The transmission of information is thus repeated several times to enable each node to integrate information from its neighbors and thus capture more and more information about the structure of the graph.

When two singularity graphs are compared with each other, the comparison of feature vectors can be performed using a mathematical function to evaluate the distance between singularity graphs.

To reduce computational effort, the comparison between two graphs of singularities can be carried out between two reduced graphs, in order to converge quickly at the outset and adjust later. To achieve this, the size of the graphs can be reduced.

One advantage of this method of comparing singularity graphs is that it supports deformations between the two graphs. The comparison function preferably implements one or more non-linear functions to perform the comparison operation, also known as “matching”.

According to one example, the process of the invention includes an optimization step to modify one of the two graphs to match the other graph based on a cost function used both between the positions of each node of the graph and also between the feature vectors of each node of the graph. This method allows the singularities of each graph to be matched. This method is particularly powerful in supporting local changes between the two graphs, while locally matching nearby areas. The method is also robust to changes in singularities in one of the two graphs, the appearance of new singularities in one of the two graphs, or the absence of singularities in one of the two graphs.

In particular, this method is more efficient than a rigid transformation method, as it supports model changes over time.

The method of comparing graphs to make them match enables a global approach to the graph and a local approach to converge towards a superposition of nodes, or the majority of nodes, with new singularities appearing close by and singularities having disappeared close by.

The global approach implements a global cost function by considering all the nodes in the graph. The adjacency matrix can be used for this purpose. A distance, e.g. Euclidean, can be calculated between the two singularity graphs in order to optimize a cost function based on the topological distance between the nodes of two graphs. The function then seeks to minimize the distance function according to at least one criterion.

According to one example, a first distance is defined between the nodes of each graph, for example, a Euclidean distance between points. A second distance can also be defined between the characteristic vectors of the nodes. Finally, a third distance can be defined between attributes or properties of the graph nodes. Attributes can correspond to node descriptors or other data such as annotations or classes. A plurality of distances can be defined to calculate the proximity between the nodes of two singularity graphs.

Note that when feature vectors are used to calculate a distance, the attributes used to calculate the feature vectors can be discriminated from those that did not. In this way, the second and third distances do not take the same criteria into account.

In one embodiment, the distances can be more or less weighted against each other in the algorithm for comparing and matching the two singularity graphs, in order to optimize calculations and achieve high matching accuracy. This weighting can, for example, be implemented to reinforce the Euclidean distance between the positions of the points in the first instance, with respect to another distance which will be reinforced in a second instance to improve convergence of the algorithm execution towards the solution, or to improve the accuracy of the matching of the two graphs. According to another example, weighting can be used to better exploit the distance between feature vectors of two graphs with respect to the descriptors of a singularity, or the Euclidean distance between the positions of points on the two graphs.

In other words, the distance used in the latter case can be expressed as a combination of different distances between the nodes of the singularity graph, it can be expressed as follows:

d=a·d₁(G₁,G₂)+b·d₂(G₁,G₂)+c·d₃(G₁,G₂), where:
d₁ is a Euclidean distance used to measure a topological distance on the 3D surface of the human body between nodes. A distance other than the Euclidean distance can also be used;
d₂ any distance defined by a metric on a space, such as a Minkowski or Chebyshev distance, or any other type of distance such as one based on the “cosine similarity” function; d₂ can be used, for example, to calculate the distance between embeddings of different nodes;
d₃ any distance defined by a metric on a space, such as a Minkowski or Chebyshev distance, or any other type of distance such as a distance based on the “cosine similarity” function; d₃ can be used, for example, to calculate the distance between descriptors of different nodes;
a, b and c are coefficients;
G₁: the graph of singularities generated at time t₁;
G₂: the graph of singularities generated at time t₂.

d is the function to be optimized.

According to another example, distance d can be expressed as a non-linear function of d₁, d₂, d₃.

In one example, the vector of coefficients a, b and c is optimized during the graph matching operation.

According to one example, if feature vectors directly or indirectly encode descriptors, only the distance d₂ can be used without having to use the distance d₃.

According to an embodiment, additional data to that of the node positions, such as the class of the similarity image, can be used to define a distance d₃. This distance d₃ can in this case define a discrete 0 or 1 when the distance between two nodes is calculated. The distance d₃ can be used with the distance d₁, for example, with or without the distance d₂.

In one embodiment, by optimizing the cost function of the distance between the two graphs, the parameters of a transformation of a first graph to match a second graph can be defined. The transformation of the whole graph can correspond to the set of transformations of the set of nodes of the similarity graph. The invention includes the application of this computed transformation to enable a display of similar portions of both graphs and more particularly of the nodes of each graph, i.e. singularity images. The images of singularities extracted from two corresponding nodes in each of the graphs are preferably displayed side by side.

In one embodiment, the corresponding node pairs of each of the two graphs are associated. The association can be achieved by means of an index, a mapping table, a database or a data file. Node association data can then be used to represent associated nodes.

According to an embodiment, the graph matching algorithm comprises an initialization phase, which includes an initial realignment of the graphs. This initial realignment of the graphs can be achieved initially by a rigid transformation designed to optimize a distance criterion between the nodes, enabling the graphs to be brought closer together in space. According to one example, this initialization phase can be used to homogenize the dimensions of the graphs. In another example, this initialization phase involves reducing one graph so that it is topologically contained within the other graph. The algorithm iterates through a homothetic transformation while optimizing the distance function.

In one embodiment, a similarity graph comprises between 50 and 600 nodes. According to one embodiment, the similarity graph comprises between 150 and 500 nodes. The node size generally depends on the individual. However, one advantage is that the size of the graph makes it possible to apply robust algorithms while keeping computation times relatively short, given that the size of the graph remains small.

1. A computer-implemented method for generating at least one differential marker of the presence of a skin singularity of a human body, said method comprising:
receiving at a first date of at least a first image of all or part of the human body, forming a first part, of a first individual for displaying a dermoscopic image extracted from said first image with dermoscopic resolution, said first image comprising a plurality of cutaneous singularities of the skin of said body, each singularity having coordinates in a first reference frame associated with said first image and being associated with a first date and at least a first value of a first descriptor, each singularity located in the first image defining a node of a first graph, each node comprising attributes including a position of the singularity and at least one value of a descriptor;
receiving at a second date of at least one second image of the same first part of the human body of the first individual with substantially identical resolution, said second image comprising a plurality of skin singularities of the skin of said body, each singularity having coordinates in a second reference frame associated with said second image and being associated with a second date and at least one second value of the first descriptor, each singularity located in the second image defining a node of a second graph, each node comprising attributes including a position of the singularity and at least one value of a descriptor;
generating a first representation comprising the first image and at least one first symbol associated with a first singularity located at a first position of said first image of the first reference frame, said at least first symbol being superimposed on the first image at the first position, said first symbol having a first geometry and/or a first color generated as a function of at least the first value of the first descriptor considered at the first date;
generating of a second representation in the vicinity of the first representation comprising the second image and at least one second symbol associated with the first singularity, said second symbol having a second geometry and/or a second color, said at least one second symbol being superimposed on the second image at the first position, said second geometry and/or said second color being different from the first geometry and/or the first color thus defining a differential marker, when the calculated distance between a first value of the first descriptor calculated at the first date and a second value of the first descriptor calculated at the second date is greater than a predefined threshold,
the two images of each representation being oriented and aligned with each other by means of a step of comparing the two graphs and minimizing the error in the positional deviation of the nodes from each other.

2. The method according to claim 1, wherein at least one feature vector is calculated at each node of the first graph and of the second graph by a machine learning model, said model receiving as input an image of a singularity and generating as output a feature vector of the similarity of said image.

3. The method according to claim 2, wherein the comparison step implements the optimization of a cost function of the calculation of a distance between two graphs taking into account:
a first distance between the nodes of the first graph and the nodes of the second graph, said first distance using a geometric metric for calculating a distance between points in space,
a second distance between the nodes of the first graph and the nodes of the second graph, said second distance using a metric for calculating a distance between feature vectors.

4. The method according to claim 2, wherein the optimization of the cost function of the distance between the two graphs enables a transformation to be applied to each node of a first graph to make it correspond to a node of the second graph.

5. The method according to claim 2 wherein the optimization of the cost function of the distance between the two graphs enables a non-rigid transformation to be applied.

6. The method according to claim 1 wherein each graph comprises between 50 and 600 nodes.

7. The method according to claim 1, wherein each singularity of the first image and/or of the second image is associated with a plurality of descriptors comprising at least one descriptor from the following list:
a contrast value with respect to a value representative of an average color considered in the vicinity of the skin singularity;
a given class of a classifier of a neural network output having been trained with dermoscopic images of skin singularities;
a characterization of a geometric shape datum,
a score corresponds to a scalar value or a numerical value obtained by implementing an algorithm processing as input an image extracted from the first image or the second image,
a score obtained by calculating different values of singularity descriptors considered in the vicinity of a given singularity.

8. The method according to claim 7, wherein when a class is associated with a singularity after acquired images of the skin are supplied to a neural network configured to output a classification of said supplied images, at least one class is comprised from the following list of classes:
a class relating to the geometry of the periphery of the singularity of a given dermoscopic photo,
a class relating to the characterization of a geometry of the periphery of the singularity of a given dermoscopic photo with respect to a plurality of characterizations of geometries of peripheries of singularities of other dermoscopic photos considered in the vicinity of the given dermoscopic photo;
a class related to the color of a singularity;
a class relating to the asymmetry of the geometry of the periphery of the singularity of a given dermoscopic image, a class relating to the diameter of the geometry of the periphery of the singularity of a given dermoscopic image, when said singularity has a substantially circular shape,
a class relating to the area in which the singularity is present on the human body.

9. The method according to claim 1, wherein an evolution criterion is calculated quantifying the evolution of a descriptor of a singularity between two images of two acquisitions made at two different dates.

10. The method according to claim 9, wherein an evolution criterion is calculated from a distance defined between a first value of a descriptor of a first node of a first graph acquired at a first date and a second value of a descriptor of a second node of a second graph acquired at a second date, each graph being generated from a first image, respectively a second image, said images corresponding to a body of the same individual and the first node and the second node having the same position within the first and second image.

11. The method according to claim 9, wherein the color and/or geometry of a symbol is/are selected according to:
a criterion for a singularity to belong to at least one class of the classifier;
a descriptor value exceeding a threshold value;
the value of an evolution criterion for a singularity descriptor calculated between two first images acquired at two dates.

12. The method according to claim 1, wherein a third symbol is generated according to a given color and/or shape when a singularity is present in a first image acquired at a given position for the first time, said color or shape of the third symbol enabling said symbol to be distinguished from another symbol to indicate the new appearance of said singularity.

13. The method according to claim 1, wherein user interaction with at least one displayed symbol generates a first digital instruction for displaying at least one dermoscopic image in a display window, said displayed dermoscopic image corresponding to an image extracted from the first image associated with the position at which the symbol is displayed on the first image.

14. The method according to claim 1, wherein a second digital instruction generated by a user action enables two dermoscopic images to be displayed side by side, extracted respectively from a first image and from a second image, said two dermoscopic images enabling the singularities of the same position on the body to be displayed at the same resolution and on the same dimensional scale.

15. The method according to claim 1, wherein a first digital command for moving, zooming or selecting an area of interest in the first image of the first representation automatically generates an identical digital command for an equivalent area of interest in the second image of the second representation.

16. The method according to claim 1, wherein a second numerical control enables a three-dimensional digital avatar of an individual's body to be oriented so as to display a portion of the body, a third numerical control enabling the said portion of the body displayed to be magnified over an area of interest, said area of interest displaying a plurality of markers each having a position on the surface of the human body in a reference frame associated with the digital avatar, each marker being associated with a singularity of the human body, a fourth digital command for selecting said marker to display a dermoscopic image extracted from the first image, said extracted image being defined around the position of the selected marker.

17. The method according to claim 1, wherein the dermoscopic images are acquired by an image-taking device configured to acquire a plurality of images of the skin of a human body of an individual and to assign to each image a position on a 3D model representing the body of said individual.

18. A system comprising an electronic terminal including a display for generating images produced by the method of claim 1 and a data exchange interface for receiving images acquired by an image acquisition device.
